(19) United States
(12) Patent Application Publication
(10) Pub. No.: US 2026/0022602 A1
(43) Pub. Date: Jan. 22, 2026

(54) ADJUSTABLE BASE FOR MOUNTING HINGES WITH DOUBLE ARTICULATED QUADRILATERAL, FOR DOOR LEAVES OF FURNITURE

(71) Applicant: D.G.N. S.R.L., MODENA (IT)

(72) Inventor: Daniele ZETTI, REGGIO EMILIA (IT)

(73) Assignee: D.G.N. S.R.L., MODENA (IT)

(21) Appl. No.: 18/997,381

(22) PCT Filed: Jul. 18, 2023
(86) PCT No.: PCT/EP2023/069932

§ 371 Date: Jan. 21, 2025

(30) Foreign Application Priority Data
Jul. 21, 2022 (IT) 102022000015300

(51) Int. Cl. E05D 7/04

(52) U.S. Cl. CPC E05D 7/0415; E05Y 2600/20; E05Y 2800/268; E05Y 2800/31; E05Y 2900/20

(57) ABSTRACT

An adjustable base for mounting hinges for items of furniture, which comprises a fixing element which can be associated with a component of an item of furniture, a supporting element which can be associated with at least one component of a hinge, guiding elements for slideably guiding the supporting element with respect to the fixing element along a longitudinal direction, and actuation elements for slideably actuating, along the longitudinal direction, the supporting element with respect to the fixing element; the fixing element comprises a pair of side walls and the supporting element comprises a pair of wings which are substantially parallel to the longitudinal direction and are arranged between the side walls on opposite sides of the longitudinal central plane, each wing being slideably associated with a respective side wall so as to define the guiding elements.

The present invention relates to an adjustable base for mounting hinges with double articulated quadrilateral, for door leaves of furniture.

With specific, but not exclusive, reference to the furniture sector, hinges with double quadrilateral are known, which are substantially constituted by a system of articulated levers with associated springs which make it possible to move door leaves that swing with respect to the fixed structure of an item of furniture, between a closed configuration and an open one. Such hinges generally have perforated coupling elements for allowing the mounting, using threaded elements or the like, inside the door leaf and the structure of the item of furniture.

Holes are provided on the door leaf and on the structure of the item of furniture, and the distribution of these holes mirrors that of the holes of the coupling elements of the hinge to be mounted, by inserting threaded fixing elements.

Typically these hinges are used to move door leaves that extend horizontally, and they are interposed between the upper wall of the structure of the item of furniture and the upper portion of the inner face of a door leaf.

During assembly of the item of furniture, it is necessary to correctly position the door leaf with respect to the structure of the item of furniture, in particular centering it horizontally. This requirement is even more evident if two or more wall cupboards are placed horizontally side by side, and their door leaves must not interfere with each other. Furthermore, if at least three wall cupboards are hung side by side, it is necessary to position the respective door leaves so as to space them apart evenly, in pairs.

To perform the horizontal centering of the door leaf with respect to the compartment of the item of furniture, currently it is necessary to dismount the hinge by unscrewing the corresponding threaded elements and reattach it, if necessary making fresh holes in the structure of the item of furniture and/or in the door leaf.

This operating mode is not devoid of drawbacks, in that it entails a considerable lengthening of working times and consequent increase in the incidence of labor costs for centering the door leaf with respect to the item of furniture, in that the worker has to proceed by attempts until the optimal position of the hinge is identified, re-loosening and re-tightening the threaded elements each time, with considerable lengthening of the working times.

Furthermore the rapidity and precision with which these interventions are performed are considerably influenced by the experience and practicality of the workers.

The aim of the present invention is to eliminate the above mentioned drawbacks in the background art by providing an adjustable base for mounting hinges with double articulated quadrilateral for door leaves of furniture that enables a horizontal adjustment of the position of the door leaf with respect to the structure of the item of furniture without requiring the dismounting, repositioning and reattachment of the component parts, and therefore with reduced labor times and costs.

Within this aim, an object of the present invention is to enable an easy and reliable adjustment independently of the level of experience of the workers.

Another object of the present invention is to make available a structure that is simple and compact, so as to not substantially modify the overall bulk and outline of the hinge in which it is incorporated, and not complicate its installation.

Another object of the present invention is to be able to adapt it to different types of hinges with double articulated quadrilateral.

Another object of the present invention is to provide a simple structure that is easy and practical to implement, safe in use and effective in operation, and of low cost.

This aim and these objects are all achieved by the present adjustable base for mounting hinges for items of furniture according to the appended claim 1 below, and optionally provided with one or more of the characteristics cited in the subsequent dependent claims.

This aim and these objects are likewise achieved by a hinge for items of furniture that incorporates the base according to the invention.

Further characteristics and advantages of the present invention will become more apparent from the detailed description of a preferred, but not exclusive, embodiment of an adjustable base for mounting hinges for items of furniture, which is illustrated for the purposes of non-limiting example in the accompanying drawings wherein:

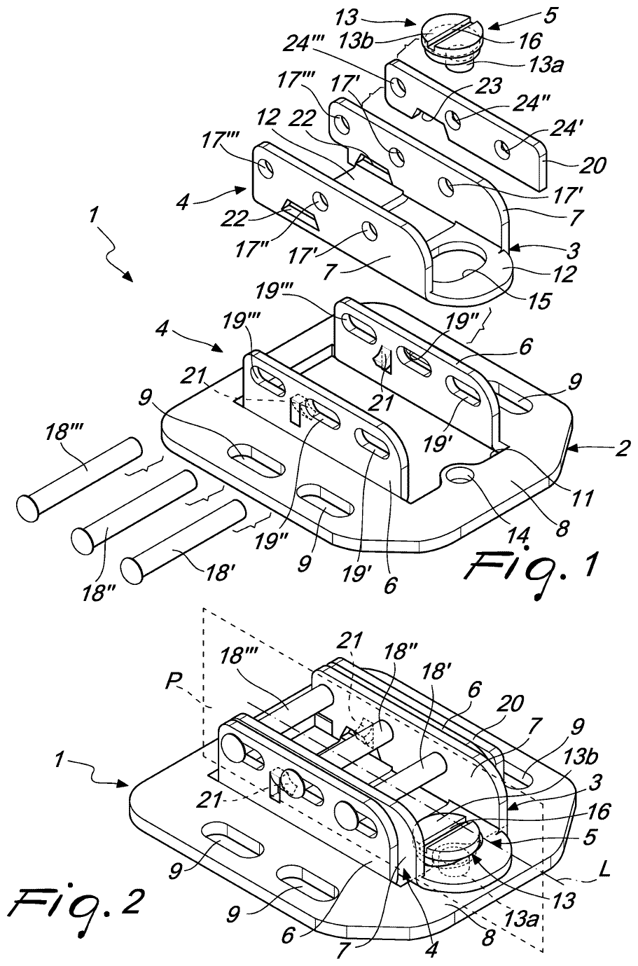

FIG. 1 is an exploded perspective view of an adjustable base for mounting hinges for items of furniture, according to the invention;

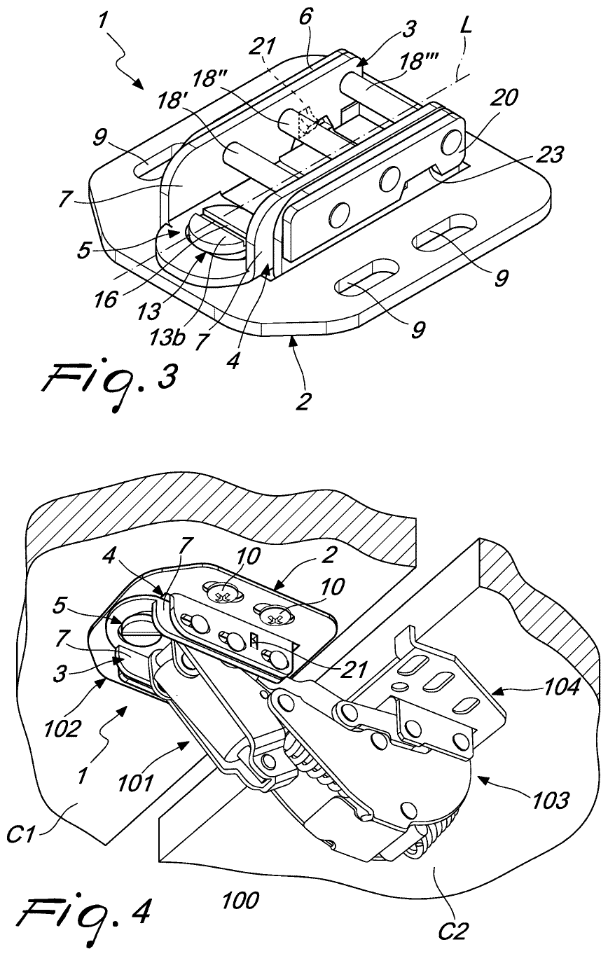

FIGS. 2 and 3 are respective perspective views of the base according to the invention, from mutually opposite viewpoints;

FIG. 4 is a perspective view of a base according to the invention applied to a hinge mounted between a door leaf and the structure of an item of furniture;

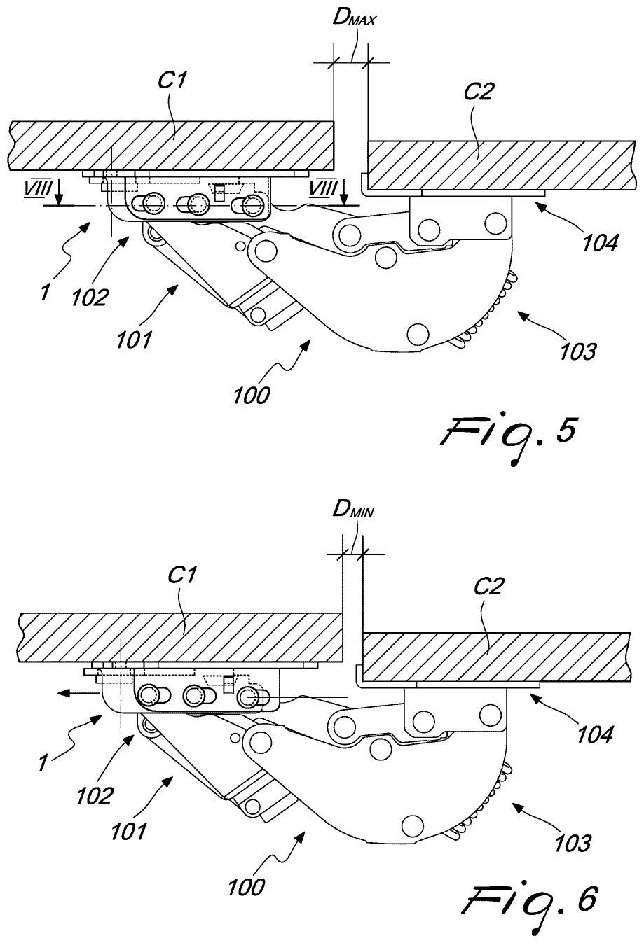

FIGS. 5 and 6 are side views of the hinge of FIG. 4 in the two extreme operating configurations of the base according to the invention;

FIG. 7 is a cross-sectional view taken along the line VII-VII of FIG. 5;

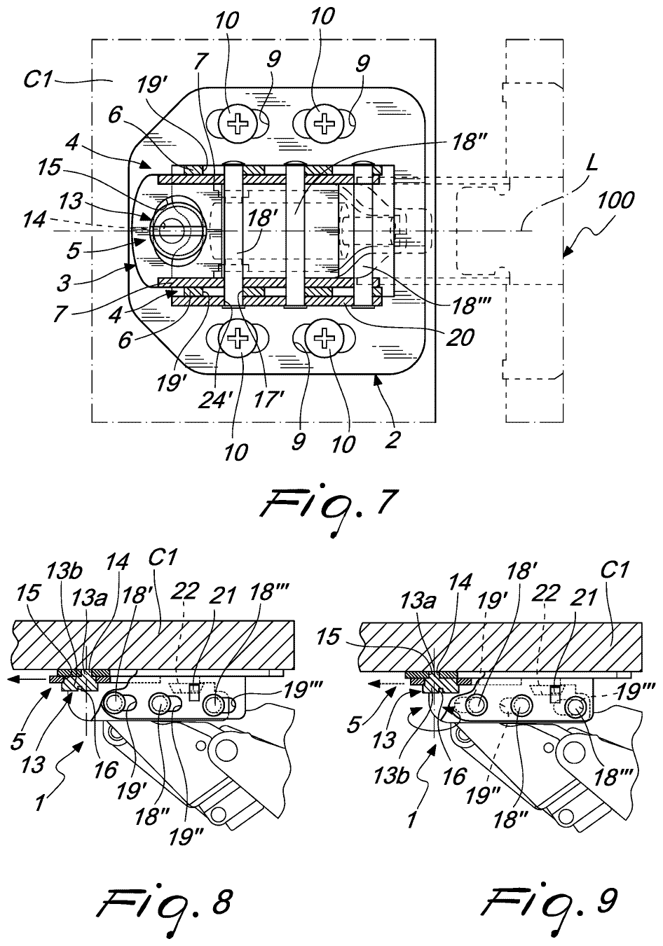

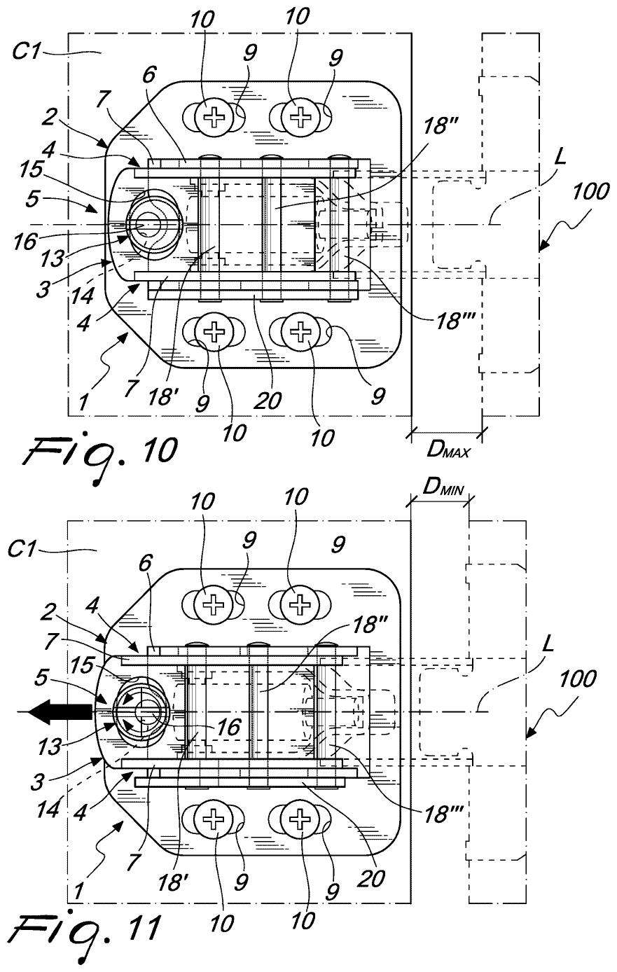

FIGS. 8 and 9 are partially cross-sectional side views of a portion of the hinge of FIGS. 5 and 6 which comprises the base according to the invention;

FIGS. 10 and 11 are views from below of a portion of the hinge of FIGS. 5 and 6 which comprises the base according to the invention.

With reference to the figures, the reference numeral 1 generally designates an adjustable base for mounting hinges for items of furniture.

The base 1 comprises a fixing element 2 which can be associated with a component of an item of furniture, a supporting element 3 which can be associated with at least one component of a hinge, guiding means 4 for slideably guiding the supporting element 3 with respect to the fixing element 2 along a longitudinal direction L, and actuation means 5 for slideably actuating, along the longitudinal direction L, the supporting element 3 with respect to the fixing element 2.

In use the base 1 is incorporated in a conventional hinge 100 with double articulated quadrilateral.

The hinge 100 is of the type that comprises a first articulated quadrilateral 101 provided with a first coupling element 102 which can be associated with a first component C1 of the item of furniture and a second articulated quadrilateral 103 provided with a second coupling element 104 which can be associated with a second component C2 of the item of furniture, the hinge 100 being adapted to assume alternatively an open configuration and a closed configuration in which at least one of the components C1 and C2 assumes a different position with respect to the other. One or both of the coupling elements 102 and/or 104 can comprise a base 1 as described below.

Each articulated quadrilateral 101 or 103 is composed of a plurality of articulated levers, which are not described in detail as they are conventional.

By way of example, in FIGS. 4-11 the hinge 100 is shown with the first coupling element 102 connected to a first fixed component C1 of an item of furniture (for example a wall of the structure of the item of furniture) and the second coupling element 104 connected to a second movable element C2 of the same item of furniture (for example a door leaf or door) and with the base 1 associated with the first coupling element 102, but alternative embodiments are not ruled out.

The hinge 100 is generally provided with elastic means associated with the articulated quadrilateral 101 and 103 which cooperate in the movement between the open configuration and the closed configuration, and can comprise damping means that act when the hinge is being closed and/or opened, such means not being shown and described in detail as they are conventional.

According to the invention, the fixing element 2 comprises a pair of side walls 6 which are substantially parallel to the longitudinal direction L and are arranged on opposite sides of a longitudinal central plane P, and the supporting element 3 comprises a pair of wings 7 which are substantially parallel to the longitudinal direction L and are arranged between the side walls 6 on opposite sides of the longitudinal central plane P, each wing 7 being slideably associated with a respective side wall 6 so as to define the guiding means 4.

In the present description the term “substantially” means “except for the usual machining tolerances and tolerances in the assembly of the component parts”.

The longitudinal central plane P (shown in dotted lines in FIG. 2) is an ideal plane that is substantially perpendicular to the principal plane of arrangement of the base 1 and comprises the longitudinal direction L. When the base 1 is incorporated in the hinge 100, the longitudinal central plane P coincides with the plane of the hinge.

In greater detail, the fixing element 2 comprises a fixing plate 8 from which the side walls 6 protrude. On the periphery of the fixing plate 8, a plurality of openings 9 are defined for the insertion of respective elements 10, such as screws or the like, for connecting to the component of the item of furniture. In the preferred embodiment shown, the fixing plate 8 has a central opening 11 because the element itself is obtained by folding a blank made of die-punched metal plate, and the side walls 6 are obtained from respective flaps, pre-cut and folded by 90° with respect to the original arrangement of this blank. However, the possibility is not ruled out of the fixing element 2 having a continuous fixing plate 8 with the side walls 6 welded to it, and/or it can be obtained using a different machining technique.

Furthermore, the supporting element 3 comprises two connecting plates 12 interposed between the wings 7. In the preferred embodiment shown, the supporting element 3 is also obtained by folding a blank of die-punched metal plate, but alternative embodiments are not ruled out.

Advantageously the actuation means 5 are arranged at the longitudinal central plane P. Preferably the actuation means 5 are arranged at one of the longitudinal ends of the base 1 along the longitudinal central plane P, so as to be easily accessible in use and to facilitate the correct movement of the supporting element 3 with respect to the fixing element 2. In use, the longitudinal end of the base 1 is designed to remain accessible externally to the hinge 100.

The actuation means 5 comprise an eccentric pivot 13 which is engaged rotationally in a seat 14 associated with the fixing element 2 and is accommodated so that it can move within a slot 15 which is substantially transverse to the longitudinal direction L and is associated with the supporting element 3. The seat 14 is defined on the fixing plate 8 at the longitudinal central plane P. The transverse slot 15 is defined in one of the connecting plates 12.

The eccentric pivot 13 comprises a cylindrical stem 13a engaged rotationally in the seat 14, and a circular head 13b misaligned with respect to the stem, which can move within the transverse slot 15.

Conveniently the circular head 13b has a minimal space occupation besides the thickness of the connector element 12 in which the transverse slot 15 is defined, so as not to interfere, in use, with the components of the hinge 100 in the open and closed configurations.

Longitudinally the transverse slot 15 has a dimension that substantially coincides with the diameter of the circular head 13b, while it has a greater transverse extension.

The circular head 13b abuts against diametrically mutually opposite portions of the periphery of the transverse slot 15 at the longitudinal central plane P (FIGS. 7 and 8), thus actuating the sliding of the supporting element 3 with respect to the fixing element 2.

The eccentric pivot 13 comprises maneuvering means 16 for rotational actuation with respect to the seat 14. Such maneuvering means 16 can comprise a coupling seat which can be associated with a tool for the rotational actuation of the eccentric pivot 13.

In the embodiment shown, the maneuvering means 16 are constituted by a linear notch defined on the circular head 13b of the eccentric pivot 13 for inserting a flat head screwdriver or the like, but they could have a cross head notch or a hexagonal socket for coupling with a different tool for the rotational actuation of the pivot.

By modifying the angular configuration of the eccentric pivot 13 it is possible to vary the relative position of the supporting element 3 with respect to the fixing element 2. When the base 1 is incorporated in a hinge 100, by way of this adjustment it is possible to vary the position of the hinge with respect to the fixing element 2 and as a consequence modify the position of the components of the item of furniture C1 and C2 between which it is mounted, as shown in FIGS. 5-6 and 9-10, which show that with the hinge 100 in the open configuration the distance between the components C1 and C2 can vary between a maximum value Dₘₐₓ and a minimum value Dₘᵢₙ as a function of the angular configuration of the eccentric pivot 13 which can vary from 0° to 180°.

The base 1 comprises at least one pair of holes 17′, each one of which is associated with one of the wings 7, which are mutually aligned transversely to the longitudinal direction L for the insertion of at least one corresponding connecting pivot 18′ which is associated with one of the components of the hinge 100, chosen from an articulated lever of one of the articulated quadrilateral 101 or 103, a spring of the elastic means, or a damping element of the damping means of the hinge.

The at least one connecting pivot 18′ can be, for example, either a pivot of one of the articulated levers of one of the articulated quadrilateral 101 or 103, or an abutment pivot, either of a spring of the elastic means or of a damping element of the damping means of the hinge 100.

The number and the distribution of the pairs of holes along the wings 7 can vary as a function of the type of hinge 100 with which the base 1 is associated.

In the embodiment shown, there are three pairs of holes 17′, 17″ and 17′″ into which respective connecting pivots 18′, 18″ and 18′′ are inserted.

Preferably the base 1 comprises at least one pair of longitudinally-elongated slots 19′, each one of which is associated with a respective side wall 6, and which are mutually aligned, transversely to the longitudinal direction L, and are arranged at the at least one pair of holes 17′. In this case the at least one connecting pivot 18′ is inserted with the mutually opposite ends passing through the side walls 6 so as to prevent the detachment of the supporting element 3 from the fixing element 2 after assembly.

In the embodiment shown, there are three pairs of slots 19′, 19″ and 19′″, each one at a respective pair of holes 17′, 17″ and 17′″ and into which a corresponding connecting pivot 18′, 18″ and 18′″ is inserted.

Alternative embodiments are not ruled out, in which the at least one connecting pivot 18′ does not protrude from the wings 7 and therefore the side walls 6 do not have the above-mentioned slots.

Furthermore, the base 1 can comprise an abutment plate 20 for riveting the end of the at least one connecting pivot 18′, which is arranged outside one of the side walls 6 with respect to the longitudinal central plane P and is provided with at least one opening 24′ in which that pivot is inserted so as to pass through.

During assembly, in fact, if connecting pivots are used which have a single contoured abutment head, then a riveting process needs to be performed on the opposite end, for which a perimetric abutment surface is needed in order to obtain a correct deformation of the end of that pivot.

In the embodiment shown, the abutment plate 20 is provided with three openings 24′, 24″, 24′″, one for each connecting pivot 18′, 18″, 18′″.

In addition, the base 1 can comprise at least one tooth 21 which protrudes from one of the side walls 6 or of the wings 7 and is accommodated so that it can move along a corresponding slit 22 which is substantially parallel to the longitudinal direction L and is associated with the corresponding wing 7 or side wall 6 so as to prevent the separation of the fixing element 2 and the supporting element 3.

Preferably there are two teeth 21, arranged on opposite sides of the longitudinal central plane P and engaged slideably in respective slits 22.

In the embodiment shown, the teeth 22 protrude from the side walls 6 toward the longitudinal central plane P and are engaged in respective slits 22 defined on the wings 7.

In particular, the teeth 21 can be obtained from flaps cut directly into the side walls 6 and folded inward after assembly, in order to be engaged in the respective slits.

The presence of the teeth 21 engaged in the respective slits 22 to prevent the detachment of the fixing element 2 and of the supporting element 3 is particularly useful if the at least one connecting pivot 18′ is interposed only between the wings 7, but in any case it also performs a safety function if the at least one connecting pivot 18′ is inserted so that it also passes through the side walls 6 and the abutment plate 20, if present.

The abutment plate 20 can have a recess 23 at the slit 22 of the corresponding side wall 6 in order to make the corresponding tooth 21 visible and accessible.

In practice it has been found that the invention as described achieves the intended aim and objects and, in particular, attention is drawn to the fact that the base according to the invention has components that are easy to provide and assemble, and the base makes it possible to easily perform a reliable adjustment of the hinge during assembly.

Furthermore the base according to the invention can be easily adapted to many and varied types of hinges with minimal structural adaptations.

Lastly, the base according to the invention is compact and does not significantly alter the bulk and outline of the hinge in which it is incorporated, so as to not complicate its installation.

The invention, thus conceived, is susceptible of numerous modifications and variations, all of which are within the scope of the appended claims.

Moreover, all the details may be substituted by other, technically equivalent elements.

In practice the materials employed, as well as the contingent dimensions and shapes, may be any according to requirements without for this reason departing from the scope of protection claimed herein.

The disclosures in Italian Patent Application No. 102022000015300 from which this application claims priority are incorporated herein by reference.

1-11. (canceled)

12. An adjustable base for mounting hinges for items of furniture, which comprises:
a fixing element, which is configured to be associated with a component of an item of furniture,
a supporting element, which is configured to be associated with at least one component of a hinge,
guiding means for slideably guiding said supporting element with respect to said fixing element along a longitudinal direction,
actuation means for slideably actuating, along said longitudinal direction, said supporting element with respect to said fixing element,
wherein said fixing element comprises a pair of side walls which are substantially parallel to said longitudinal direction and are arranged on opposite sides of a longitudinal central plane, and wherein said supporting element comprises a pair of wings which are substantially parallel to said longitudinal direction and are arranged between said side walls on opposite sides of said longitudinal central plane, each wing being slideably associated with a respective one of said side walls so as to define said guiding means.

13. The base according to claim 12, wherein said actuation means are arranged at said longitudinal central plane.

14. The base according to claim 12, wherein said actuation means are arranged at a longitudinal end of said base.

15. The base according to claim 12, wherein said actuation means comprise an eccentric pivot which is engaged rotationally in a seat associated with said fixing element and is accommodated so that it can move within a slot which is substantially transverse to said longitudinal direction and is associated with said supporting element.

16. The base according to claim 15, wherein said eccentric pivot comprises maneuvering means for rotational actuation with respect to said seat.

17. The base according to claim 16, wherein said maneuvering means comprise a coupling seat which is configured to be associated with a tool for the rotational actuation of said eccentric pivot.

18. The base according to claim 12, further comprising at least one pair of holes, each hole being associated with one of said wings, which are mutually aligned transversely to said longitudinal direction for the insertion of at least one corresponding connecting pivot of said at least one component of said hinge.

19. The base according to claim 18, further comprising at least one pair of longitudinally-elongated slots, each one of which is associated with one of said side walls, and which are mutually aligned, transversely to said longitudinal direction, and are arranged at said at least one pair of holes, the at least one connecting pivot being inserted so as to pass through the side walls.

20. The base according to claim 18, further comprising an abutment plate for riveting an end of said at least one connecting pivot, which is arranged outside one of said side walls with respect to said longitudinal central plane and is provided with at least one opening in which said at least one pivot is inserted so as to pass through.

21. The base according to claim 12, further comprising at least one tooth which protrudes from one of said side walls or of said wings and is accommodated so that it is configured to move along at least one corresponding slit which is substantially parallel to said longitudinal direction and is associated with a corresponding wing of said wings or said side wall so as to prevent a separation of the fixing element and the supporting element.

22. A hinge for items of furniture, which comprises a first articulated quadrilateral provided with a first coupling element which is configured to be associated with a first component of an item of furniture and a second articulated quadrilateral provided with a second coupling element which is configured to be associated with a second component of said item of furniture, the hinge being adapted to assume alternatively an open configuration and a closed configuration, wherein at least one of said coupling elements comprises a base according to claim 12.
